(19) United States
(12) Patent Application Publication
(10) Pub. No.: US 2009/0253932 A1
(43) Pub. Date: Oct. 8, 2009

(54) Resolution of Racemic Organic Acids with (1S, 4S)-4[3,4-Dichlorophenyl]-1,2,3,4-Tetrahydro-N-Methyl-1-Naphthaloneamine

(75) Inventors: Chava Satyanarayana, Secunderabad (IN); Bandari Mohan, Hyderabad (IN); Madhuresh Kumar Sethl, Hyderabad (IN)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Matrix Laboratories Ltd, Secunderabad (IN)

(21) Appl. No.: 11/794,278

(22) PCT Filed: Jul. 28, 2005
(86) PCT No.: PCT/IN05/00251

§ 371 Date: Aug. 25, 2008

(30) Foreign Application Priority Data
Aug. 2, 2004 (IN) 746/CHE/2004

(51) Int. Cl. C07B 55/00

(52) U.S. Cl. 562/401

(57) ABSTRACT

The present invention relates to novel chiral resolving agents and a process for resolution of racemic organic acids and their derivatives of the formula (+, −)—R₁R₂CHCOOR3 with Cis-(1S,4S)-4[3,4-dichlorophenyl]-1,2,3,4-tetrahydro-N-methyl-1-naphthaloneamine and its Cis-(1R,4R)-isomer as well as Trans-(1S,4R)-4[3,4-dichlorophenyl]-1,2,3,4-tetrahydro-N-methyl-1-naphthaloneamine and its Trans-(1R,4S)-isomer.

The present invention relates to a process for resolution of racemic organic acids and their derivatives of the formula (±)-R₁R₂CHCOOR₃ with Cis-(1S,4S)-4[3,4-dichlorophenyl]-1,2,3,4-tetrahydro-N-methyl-1-naphthaloneamine and its Cis-(1R,4R)-isomer as well as Trans-(1S,4R)-4[3,4-dichloro phenyl]-1,2,3,4tetrahydro-N-methyl-1-naphthaloneamine and its Trans-(1R,4S)-isomer.

### BACKGROUND OF THE INVENTION

Racemic compounds are mixture of enantiomers/diastereomers, which have identical physical properties; they are not separable by simple direct methods such as distillation, chromatography or crystallization. They may be separated in the presence of a chiral influence that introduces diastereomeric relationships.

U.S. Pat. No. 4,520,205 discloses the resolution of (R,S)-Indoline-2-carboxylic acid or (±)-2,3-dihydroindoline-2-carboxylic acids using ephedrine as a chiral resolving agent.

European Pat. No. 0,171,616 discloses the use of alpha-amino-epsilon-caprolactam as a resolving agent for N-acetylindoline-2-carboxylic acid.

U.S. Pat. No. 4,614,806 discloses the asymmetric synthesis of chiral Indoline-2-carboxylic acid.

U.S. Pat. No. 4,665,087 discloses the use of L-cinchonidine as chiral resolving agent for (R,S)-1-acetylindoline-2-carboxylic acid or (±)-2,3-dihydroindoline-2-carboxylic acids.

German Pat. No. 3,727,411, European Pat. No. 0,197,474 and Japanese Pat. No. 06,296,499 discloses microbial or ennymatic methods for the preparation of optically active Indoline-2-carboxylic acid.

European Pat. No. 937714 discloses the use of a chiral α-hydroxylamine as resolving agent for resolution of (R,S)-Indoline-2-carboxylic acid and other derivatives.

Japanese Pat. Appl. No. 2001/294573 discloses the preparation of optically active indoles by optical resolution using HCR₄R₅NHR_{6′} where R₄, R₅ and R₆ have the meaning cited therein. e.g (S-(4-benzyloxybenzyl)-α-methylbenzylamine in ethanol to give (R)-(+)-2-carboxy indoline salt, which was cleaved to afford (R)-(+)-2-carboxy indoline.

European Pat. No. 1,348,684 discloses the use of (R)-α-methylbenzylamine for the resolution of (R, S)indoline-2-carboxylic acid.

Nature provides a group of optically active amines (bases) called alkaloids such as ephedrine, quinine, brucine and strychnine. However, some of these resolving agents are restricted substances and their other isomers are not easily obtainable i.e., (+)-isomers are not easily obtainable.

Other optically active amines such as α-methyl-β-phenylethylamine, this amine is potentially useful as resolving agent. However, the amine (amphetamine) is a central nervous system (CNS) active compound, and accordingly it is controlled substance. Like all such substances (e.g., deoxyephedrine and morphine) it is difficult to obtain. The acquisition of controlled substances for use as resolving agents is so complicated and time consuming.

Some resolving agents are awkward to use and to store without precaution. Liquid primary anines, such as α-Methylbenzylamine hydrogen sulfate and α-(1-naphthyl) ethylamine phenylacetate are examples of salts that are conglomerates. All other things being equal, high expenses are a negative feature in the choice of a resolving agent, although this feature may be mitigated by the possibility of recovery and reuse. When preparation of a resolving agent is required, the yield and complexity of the synthesis is likely to be a consideration.

Because of above disadvantages, there is a longstanding demand for the chiral resolving agent and its other chiral isomers which are readily available/produced in large volume with high enantiomeric purity, low toxicity, good solubility, storage and reusability.

The majority of resolutions mediated by diastereomers (diastereomeric salts mixtures, in particular) have been based on solubility differences of solids. Some of the resolving agents have been designed that incorporate many features listed above. The development of chirally pure new drugs is a topic of great current interest in the pharmaceutical industry. A high proportion of the enantiomerically pure pharmaceuticals are of natural origin, while the majority of synthetic products are manufactured as racemates. Presently, the numbers of nmarketed racemates are overtaken by synthetic/semi-synthetic single isomer, discarding unwanted isomers as waste material in the process. One of the most successful drug marketed as a single isomer is sertraline.

N-Methyl-4-(3,4-dichorophenyl)-1,2,3,4-tetrahydro-1-naphthaleneamine exists in four, possible stereo isomers as shown below. Hydrochloride salt of Cis-(1S, 4S) isomer i.e. Cis (1S, 4S)-N-methyl-4-(3,4-dichlorophenyl)-1,2,3,4-tetrahydro-1-naphthaleneamine revealed the required high selectivity for serotonin residues. This has limited side effects of tricyclic anti depressant with greatly enhanced selectivity for specific mechanism of actions believed to be essential for anti-depressant efficacy.

Other three stereo isomers are not of much use so far, hence these are treated as waste or converted back to active stereo isomer using a very long process. Therefore, there is a need to find out some other use of industrial importance for all the stereo isomers.

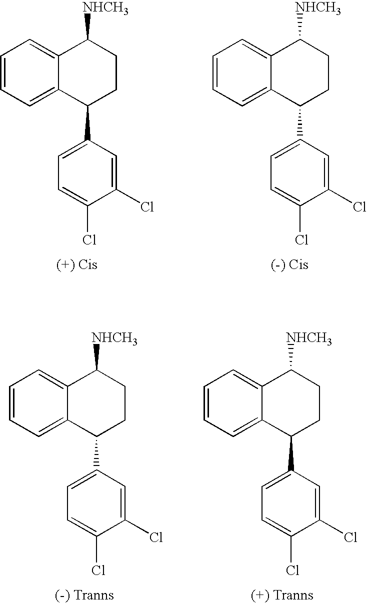

Surprisingly, it is found that Cis-(1S, 4S)4[3,4-dichlorophenyl]-1,2,3,4-tetrahydro -N-methyl-1-naphthaloneamine (Sertraline) and its Cis-(1R, 4R)-isomer as well as Trans-(1R, 4S)-4[3,4-dichlorophenyl]-1,2,3,4-tetrahydro-N-methyl-1-naphthalonearnine and its Trans-(1S, 4R) isomer are useful resolving agents for the resolution of racemic organic acids resolve for acidic racemic organic compounds and their derivatives of the formula: R₁R₂CHCOOR₃, where R₁=R₂ or different or form cyclic substitution which may be aromatic or non-aromatic or R₁, R₂ may be H, alkyl, sub-alkyl; aryl, sub-aryl or amino and substituted amino; R₃ may be H, sub-alkyl or sub-aryl derivative. This is illustrated in Scheme-I in which (1S, 4S)-Sertraline used as example for the resolution of Racemic acid organic compounds and their derivatives.

Accordingly, the present invention is to provide a good resolving agent, which is readily available with high enantiomeric purity having low toxicity, good solubility, stability, storage and reusability.

### SUMMARY OF THE INVENTION

The main object of this invention is to provide Sertraline and its other chiral isomers as chiral resolving agents.

Another object of the invention is to provide Sertraline and its other isomers as a chiral resolving agent for resolution of acidic recemic organic compounds and their derivatives.

Another object of the invention is to provide Sertraline and its other isomers as chiral resolving agents to form diastereomer salts of acidic recemic organic compounds and their derivatives, which are separable by simple direct methods based on their physical properties.

Another object of this is to provide Sertraline and its other isomers as a chiral a resolving agent to form diastereomer salts of acidic recemic organic compounds and their derivatives, which can be converted to respective, resolved chiral isomers.

These and other objects of the invention will become more apparent in the detailed description and examples given therein.

### DETAILED DESCRIPTION OF THE INVENTION

Optically active Cis-(1S, 4S)-4[3,4-dichlorophenyl]-1,2,3,4-tetrahydro -N-methyl-1-naphthaloneamine or Sertraline and its other chiral isomers is readily prepared by conventional standard methods reported in literature.

Cis-(1S,4S)-4[3,4-dichlorophenyl]-1,2,3,4-tetrahydro-N-methyl-1-naphthaloneamine (Sertraline) and its chiral isomer Cis-(1R, 4R)-isomer as well as trans-(1R, 4S)-4[3,4-dichlorophenyl]-1,2,3,4-tetrahydro-N-methyl-1-naphthaloneamine and its trans-(1S, 4R) isomer can be employed as chiral resolving agents for the resolution of racemic organic acids and their derivatives of the formula: R₁R₂CHCOOR₃, where R₁=R₂ or different or form cyclic substitution which may be aromatic or non-aromatic or R₁, R₂ may be H, alkyl, sub-alkyl; aryl, sub-aryl or amino and substituted amino; R₃=H or derivative as illuted in Scheme-I.

The resolution of racemic acids for example indoline-2-boxylic acid is carried out in solvents such as ethyl acetate, acetonitrile, water and alcohols, preferably in ethyl acetate and isopropyl alcohol.

The resolving agent in this invention is used at a ratio of 0.1 to 2.0 moles, preferably 0.5 to 0.9 mole based on one mole of racemic carboxylic acid.

The reactions of the resolving agent with racemic carboxylic acids in this invention are carried out according to the following standard methods. Racemic carboxylic acid and the resolving agent are separately dissolved in each solvent and then both solutions are mixed. As another method, both compounds are dissolved by turns in the solvent.

The resulting solution is cooled or concentrated and diastereomeric salts are separated. This fractional crystallization is run at the temperature between the freezing point and the boiling point of the solvent used, preferably 0° C. to 80° C.

The resulting diastereomeic salts can be converted into the free compounds, by liberating the latter with stronger acids or bases. Thus optically active carboxylic acid or its other isomer can be obtained as crystalline product in good yield and high chiral purity.

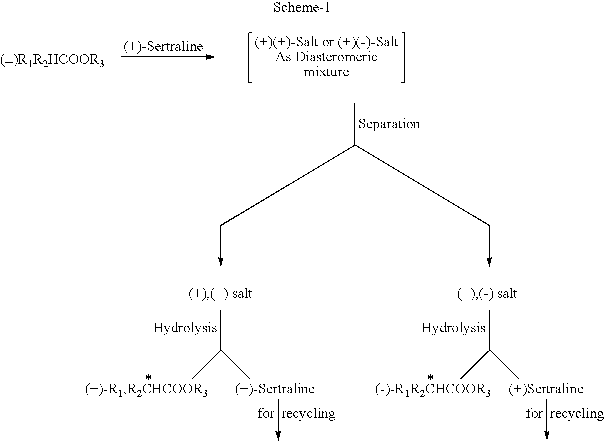

The invention will be more clearly understood with reference to the following Examples.

### EXAMPLE 1

### Preparation of (R)-Indoline-2-Carboxylic Acid Salt

10 g of (R, S)-Indoline-2carboxylic ac is suspended in 100 ml ethyl acetate at 25-30° C. To this a solution of 20 g of (1R, 4R)-4[3,4-dichlorophenyl]-1,2,3,4-tetrahydo-N-methyl-1-naphthaloneamine dissolved in 200 ml of ethyl acetate and heated to reflux. The reaction mass is refluxed for 1 hr and then cooled. The product is filtered, washed with 10 ml of ethyl acetate and dried to give 9.0 g.
Specific optical rotation: −20.6° (c=1, methanol)

### EXAMPLE 2

### Preparation of (R)-Indoline-2-Carboxylic Acid

8 g of (R)-Indoline-2-carboxylic acid salt is suspended in a mixture of 35 ml of ethyl acetate and 15 ml of DM water at 25-30° C. The pH of the solution is adjusted to 10.5-11.0 with 15% sodium hydroxide solution to get a clear biphasic solution. The layers are separated and the pH of the aq. layer is adjusted to 4.4-4.8 with dilute HCl solution. The precipitate obtained is cooled and filtered and dried to get 2 g of title compound

| | |
|---|---|
| Melting range | 168-169° C. (decomposition) |
| Specific optical rotation | +99.87° (Solvent, C = 1, 1N HCl) |

### EXAMPLE 3

### Preparation of (S)-Indoline-2-Carboxylic Acid Salt

100 g of (R, S)-Indoline-2-carboxylic acid is suspended in 800 ml ethyl acetate. To this a solution of 94 g of (1S,4S)-4[3,4-dichlorophenyl]-1,2,3,4-tetrahydro-N-methyl-1-naphthaloneamine dissolved in 600 ml of ethyl acetate is added and heated to reflux. The reaction mass is refluxed for 1-2 hrs and cooled. The product is filtered, washed with 100 ml of ethyl acetate and dried to give 80 g crystalline salt.
Specific optical rotation: +21.53° (c=1, methanol)

### EXAMPLE 4

### Preparation of (S)-Indoline-2-Carboxylic Acid

80 g of (S)-Indoline-2-carboxylic acid salt is suspended in 300 ml of ethyl acetate at 30° C. 150 ml of DM water is added to the suspension and stirred for 20 min. 15% NaOH solution is slowly added and adjusted pH to above 10. The clear solution is stirred and the layers are separated. The pH of aq layer is adjusted at about 4 to 5 with dil. HCl. The precipitate is cooled, filterer and washed with water. Dry the material at 60-65° C. to get 24.1 g of pure material.

| | |
|---|---|
| Melting range | 171° C.-173° C. (decomposition) |
| Specific optical rotation (at 26° C.) | −117.38° (C = 1, IN HCl) |

### EXAMPLE 5

### Preparation of (R)-Mandelic Acid Salt

20 g of (R, S)-Mandelic acid is suspended in 300 ml of ethyl alcohol at 25 -30° C. Add 20 g of (1 S,4S)-4[3,4-dichlorophenyl]-1,2,3,4-tetrahydro-N-methyl-1-naphthaloneamine in 300 ml alcohol to this solution. Stir for 10-20 min. The reaction mass is refluxed for 2 hrs at 76-78° C. The reaction mass is cooled to 20-30° C., filtered and washed with 20 ml of ethyl alcohol and dried to give 17.5 g title product.
Specific optical rotation (at 26° C.): −18.8 (c=1, methanolic HCl)

### EXAMPLE 6

### Preparation of (R)-Mandelic Acid

17 g of (R)-Mandelic acid salt is suspended in 55 ml of ethyl acetate at 30° C. and 45 ml of DM water is added to the suspension and stirred for 20 min. 30 ml of 15% NaOH solution is slowly added to this solution at 20-25° C. up to get pH 9-10.0. The clear solution is stirred for 30 min at 30° C., the layers are separated. The pH of aq layer is adjusted to 2 with dil HCl & extracted with 3×40 ml ethyl acetate. Combined organic layer is dried and concentrated under reduced pressure to give 5 g of title compound.

Specific optical rotation (at 26° C.): −136.2 (c=2.5, water)

### EXAMPLE 7

### Preparation of (L)-Lactic Acid Salt

10 g of (DL)-Lactic acid and 17 g of cis-(1S, 4S)-4[3,4-dichlorophenyl]-1,2,3,4-tetrahydro-N-methyl-1-naphthaloneamine in 20 ml of ethyl acetate are refluxed for 1 hr at 76-78° C. The reaction mass is cooled to 30° C. Solvent is removed under vacuum. Residue is stirred wiih IPE & dioxane, filtered to give 16.6 g of title compound.

Specific optical rotation (at 26° C.): +10.2 (c=1, water)

### EXAMPLE 8

### Preparation of (L)-Lactic Acid

15 g of (L)-Lactic acid Salt is suspended in 150 ml of ethyl acetate & 30 ml of DM water. 20 ml of 15% NaOH solution is slowly added to this solution at 20-25° C. to get pH 9-10. The clear solution is stirred for 30 min. at 30° C. The layers are separated and the pH of aq layer is adjusted to 3.5 with dil HCl & extracted with 3×50 ml of ethyl acetate. Solvent is removed under reduced pressure gave 2.0 g of title compound as oil.
Specific optical rotation (at 26° C.): +1.0 (c=2.5, CHCl₃)

### EXAMPLE 9

### Preparation of (R)-Naproxen salt

20 g of (R, S)-Naproxen is suspended in 60 ml of ethyl acetate at 25-30° C. Heated to 40-45° C. a solution of 13.4 g of (1S,4S)-4[3,4-dichlorophenyl]-1,2,3,4-tetrahydro-N-methyl-1-naphthaloneamine in 60 ml methyl alcohol is added. Stirred for 10-20 min. The reaction mass is refluxed for 2 hrs at 76-78° C. The reaction mass is cooled to 0° C., filtered and washed with 20 ml of ethyl acetate and dried to give 19.5 g of title compound.

Specific optical rotation (at 26° C.): +25.2 (c=1, Chloroform)

### EXAMPLE 10

### Preparation of (R)-Naproxen

15 g of (R)-Naproxen salt is suspended in 150 ml of ethyl acetate at 30° C. 30 ml of DM water is added to the suspension and stirred for 20 min. 25 ml of 15% NaOH solution is slowly added to this at 20-25° C. to get pH 9-10. The clear solution is stirred for 30 min. at 30° C. The layers are separated and the aq layer is adjusted to pH ˜6 with dil HCl. & extracted in 50 ml ethyl acetate to give 5 g of title compound.

Specific optical rotation (at 26° C.): −20.8 (c=1, CHCl₃)

### EXAMPLE 11

### Preparation of (S)-Naproxen

15 g of (R, S)-Naproxen is suspended in 75 ml of ethyl acetate at 25-30° C. 20 g of (cis)-(1S,4S)-4[3,4-dichlorophenyl]-1,2,3,4-tetrahydro-N-methyl-1-naphthaloneamine in 75 ml ethyl acetate is added to this solution. The reaction mass is refluxed for 2 hrs. Ethyl acetate is removed under vacuum & resulting mass is stirred with methanol/ethyl acetate mixture below 0° C. The reaction mass is filtered to remove the solid & solution is concentrated under reduced pressure to give (S)-Naproxen salt as thick oil. (S)-Naproxen salt is suspended in 50 ml of ethyl acetate & 10 ml of DM water and stirred for 10 min. 15 ml of 15% NaOH solution is slowly added to this at room temperature to get 9-10 pH. The clear solution is stirred for 30 min. The layers are separated and aqueous layer is adjusted to pH 4-5 with dil HCl to get the precipitate of (S)-Naproxen. The product is filtered & dried at 40-50° C. to give 1.5 g of (S)-Naproxen.

Specific optical rotation (at 26° C.): +50.26 (c=1, CHCl₃);

### EXAMPLE 12

### Preparation of (D)-Tyrosine Salt

5 g of (DL)-Tyrosine is suspended in 40 ml of ethyl acetate at 25-30° C. Heated to 40-45° C. 4.2 g of (1S,4S)-4[3,4-dichlorophenyl]-1,2,3,4-tetrahydro-N-methyl-1-naphthalone amine in 35 ml methanol is added to this solution. Stirred for 10-20 min. The reaction mass is refluxed for 3 hrs at 76-78° C.The reaction mass is cooled to 30° C., filtered and washed with 5 ml of ethyl acetate and dried to give 5.1 g title compound

Melting range: 295.6-298.6° C.

### EXAMPLE 13

### Preparation of (D)-Tyrosine

3.8 g of (D)-Tyrosine salt is suspended in 15 ml of ethyl acetate at 30° C. 15 ml o DM water is added to the suspension and stirrd for 20 min. 15 ml of 15% NaOH solution is slowly added to this at 20-25° C. to get pH 10.0 -10.5. The clear solution is stirred for 30 min. at 30° C. The layers are separated and aq.layer is adjusted to pH ˜3.5 with dil HCl & extracted in 50 ml of ethyl acetate to give 1.3 g of title compound.

Specific optical rotation (at 26° C.) : +1.72 (c=4, 1N HCl)

### EXAMPLE 14

### Preparation of (R)-Mandelic Acid Salt

3 g of (R, S)-Mandelic acid is suspended in 45 ml ethyl alcohol at 25-30° C. Add to this solution of 3 g of trans-(1S,4R)-4[3,4-dichlorophenyl]-1,2,3,4-tetrahydro-N-methyl-1-naphthaloneamine freebase in 45 ml alcohol. The reaction mass is refluxed for 2 hrs. The reaction mass is slowly cooled to 20-30° C. & further cooled to below 0° C., filtered and dried to give 1.6 g title product.

Specific optical rotation (at 26° C.): −2.2 (c=1, methanolic HCl)

### EXAMPLE 15

### Preparation of (R)-Mandelic Acid

1.4 g of (R)-Mandelic acid salt is suspended in 50 ml ethyl acetate and 10 ml of DM water is added to the suspension and stirred for 5 min. 4 ml 15% NaOH solution is slowly added at 20-25° C. up to pH of 9.0-10.0. The clear solution is stirred for 30 min at 30° C. and the layers are separated. Aq layer is washed. with 3×25 ml of ethyl acetate. The pH of aq layer is adjusted to 3.0 with dil. HCl & extracted with 3×25 ml of ethyl acetate. Combined organic layer is dried and concentrated under reduced pressure to give 0.25 g of title compound.

Specific optical rotation (at 26° C.): −110 (c=1, water)

1. A process for the resolution of racemic organic acids and their derivatives of the formula (±) R₁R₂CHCOOR₃ with the cis-isomer of 4-[3,4-dichlorophenyl]-1,2,3,4-tetrahydro-N-methyl-l-naphthaloneamine or the trans-isomer of 4-[3,4-dichlorophenyl]-1,2,3,4-tetrahydro-N-methyl-l-naphthaloneamine, wherein
R₁=R₂ or different or form a cyclic substitution which may be aromatic or non-aromatic, R₁ and R₂ may be H, alkyl, sub-alkyl, aryl, sub-aryl, amino or subamino; R₃ may be H, sub-alkyl or sub-aryl derivative comprising
treating the racemic carboxylic acid with the resolving agent,
isolating the formed diastereomeric salt and
separating the required enantiomer from the diastereomeric salt.

2. The process as claimed in claim 1, wherein the cis-isomer of 4-[3,4-dichlorophenyl]-1,2,3,4-tetrahydro-N-methyl-l-naphthaloneamine is cis-(1S, 4S)-4-[3,4-dichlorophenyl]-1,2,3,4-tetrahydro-N-methyl-l-naphthaloneamine or cis-(1R,4R)-4-[3,4-dichlorophenyl]-1,2,3,4-tetrahydro-N-methyl-l-naphthaloneamine.

3. The process as claimed in claim 1, wherein the trans-isomer of 4-[3,4-dichlorophenyl]-1,2,3,4-tetrahydro-N-methyl-l-naphthaloneamine is trans-(1S, 4R)-4-[3,4-dichlorophenyl]-1,2,3,4-tetrahydro-N-methyl-l-naphthaloneamine or trans-(1R,4S)-4-[3,4-dichlorophenyl]-1,2,3,4-tetrahydro-N-methyl-l-naphthaloneamine.

4. The process as claimed in claim 1, wherein the resolution of the racemic carboxylic acid is carried out in an organic solvents such as ethyl acetate, acetonitrile, or alcohols or in water, preferably in ethyl acetate or isopropyl alcohol.

5. The process as claimed in claim 1, wherein the resolution of the racemic carboxylic acid is carried out by using the resolving agent in a ratio of 0.1 to 2.0 mol, preferably 0.5 to 0.9 mole per mole of racemic carboxylic acid.

6. The process as claimed in claim 1, wherein the racemic carboxylic acids are indoline carboxylic acids, 2-arylpropionic acids (profens) or amino acids.

7. The process as claimed in claim 6, wherein the indoline carboxylic acid is preferably indoline-2-carboxylic acid.

8. The process as claimed in claim 6, wherein the 2-arylpropionic acid (profen) is Naproxen.
